(19) United States
(12) Patent Application Publication
(10) Pub. No.: US 2003/0000398 A1
(43) Pub. Date: Jan. 2, 2003

(54) Offset lithographic printing press apparatus

(76) Inventor: Earl N. Barroso, Cypress, TX (US)

Correspondence Address: Bill B. Berryhill, Suite 280, 6300 West Loop South, Bellaire, TX, 77401, US

(21) Appl. No.: 09/895,704

(22) Filed: Jul. 2, 2001

(51) Int. Cl. B41L 23/00

(52) U.S. Cl. 101/148

(57) ABSTRACT

Apparatus for an offset lithographic printing press having a master cylinder on which a lithographic printing plate may be mounted for rotating contact with the surface of a blanket cylinder and having a set of dampening rollers for applying a fountain solution to the printing plate and a separate set of ink rollers for applying ink to the printing plate. The set of ink rollers has at least one ink form roller for engagement with the printing plate for applying ink thereto prior to engagement of the printing plate with the blanket cylinder. The set of dampening rollers has a dampening form roller which engages the printing plate after engagement by the ink form roller for applying fountain solution thereto prior to engagement of the printing plate with the blanket cylinder.

### BACKGROUND OF THE INVENTION

1. Field of the Invention

The present invention pertains to offset lithographic printing presses. More specifically, the present invention pertains to lithographic printing presses which utilize ink and a water based fountain solution.

2. Description of the Prior Art

Lithographic printing presses employ sets of rollers for applying ink to paper. Paper is fed between a blanket cylinder and an impression cylinder and an impression of wet ink is left on the paper by the blanket cylinder. Prior to contact with the paper, the blanket cylinder is inked by a printing plate which is carried on a plate or master cylinder. The printing plate is inked by a set of inking rollers. Multi-color presses employ a set of inking rollers, a blanket cylinder, an impression cylinder and a master cylinder for each color.

The printing plate which is attached to the master cylinder is chemically treated to provide hydrophilic (water-loving) areas and separate oleophilic (oil-loving) areas. These hydrophilic and oleophilic areas are arranged in patterns to produce a desired printing image on the paper. Ink is attracted to the oleophilic areas and repelled from hydrophilic areas. As the plate cylinder and the printing plate thereon rotates, inking rollers apply ink to the oleophilic areas on the printing plate.

Printing ink is relatively viscous. For this reason, the printing ink should be applied to the printing plate with a proper amount of fountain solution. Fountain solutions are primarily water mixed with other chemicals. If too much fountain solution is applied to the printing plate, the printed paper may lose color and fade. If an insufficient amount of fountain solution is applied to the printing plate, print clarity may be reduced and print may appear in unwanted areas.

There are generally two types of dampening systems for applying fountain solution to the printing plate. One type of dampening system applies the fountain solution directly to the printing plate with a separate set of dampening rollers. The other type of dampening system applies the fountain solution to the printing plate indirectly through the ink. The ink on the inking rollers is dampened with the fountain solution before it is applied to the printing plate. This type of system is sometimes referred to as an integrated system.

In prior art systems in which a fountain solution is applied directly to the printing plate by a separate set of dampening rollers, a dampening form roller applies the fountain solution to the printing plate prior to ink being applied thereto by the set of inking rollers. In dampening systems which apply fountain solution directly to the printing plate prior to ink being applied thereto, streaking sometimes occurs in the printed areas because the fountain solution is unevenly distributed on the printing plate. Improvements in systems of this type are needed.

### SUMMARY OF THE PRESENT INVENTION

The present invention provides apparatus for an offset lithographic printing press employing a dampening system of the type which applies the fountain solution directly to the printing plate with a separate set of dampening rollers. It provides a set of dampening rollers having at least one dampening form roller which engages the printing plate and a separate set of inking rollers which provides at least one ink form roller which engages the printing plate. An important feature of the present invention is the arrangement of the set of dampening rollers so that the dampening form roller engages the printing plate after engagement of the printing plate by the ink form roller but applying fountain solution to the printing plate prior to engagement of the printing plate with the blanket cylinder. This distinguishes the present invention from the prior art in which the fountain solution is applied to the printing plate prior to ink being applied thereto.

There are several objects and benefits of the system of the present invention. First and foremost, it provides greater clarity of print than prior art systems which apply the fountain solution directly to the printing plate prior to ink being applied thereto. It results in better balance between the fountain solution and ink. It requires less fountain solution and increases the ability to lay down more ink and to lay larger and better ink solids. Furthermore, the improved printing made possible by the system of the present invention could result in reduction of the number of dampening rollers and ink rollers and, consequently, reduce the overall cost of the printing press. Other objects and advantages of the invention will be apparent from reading the description which follows in conjunction with the accompanying drawings.

### BRIEF DESCRIPTION OF THE DRAWINGS

FIG. 1 is a schematic end view of portions of a lithographic printing press showing master and blanket cylinders, a set of inking rollers and a separate set of dampening rollers as in systems of the prior art; and

FIG. 2 is a schematic end view of portions of a lithographic printing press showing master and blanket cylinders, a set of inking rollers and a separate set of dampening rollers according to a preferred embodiment of the present invention.

### DESCRIPTION OF A PREFERRED EMBODIMENT

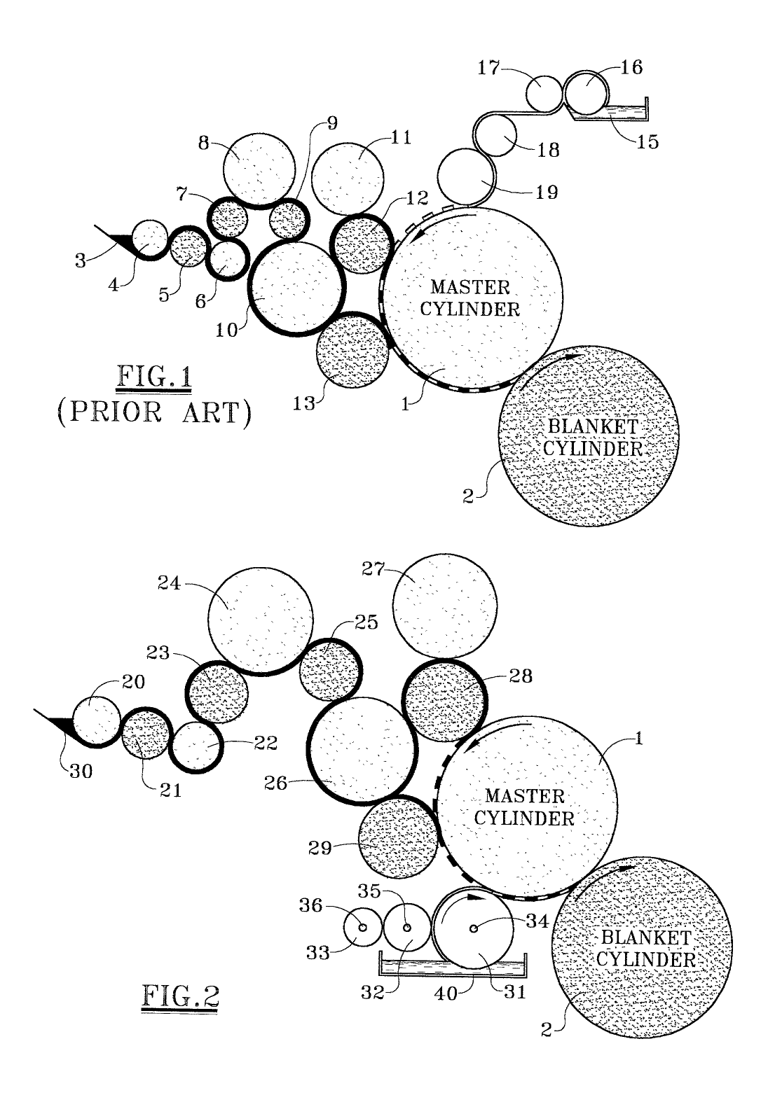

Referring first to FIG. 1, there is shown a schematic end view of rollers in a lithographic printing press for applying a single color, such as black, to paper. The impression which is to be printed on the paper is formed on a blanket cylinder 2 by engagement with a printing plate carried on the master or plate cylinder 1. The paper is fed between the blanket cylinder and an impression cylinder (not shown) where the impression is transferred from the blanket cylinder to the paper. The prior art system shown in FIG. 1 provides a reservoir of ink 3 and a set of ink rollers 4, 5, 6, 7, 8, 9, 10, 11, 12 and 13. These rollers are called by various names. For the present purposes it is only necessary to designate rollers 12 and 13 as ink form rollers. The ink form rollers 12 and 13 apply ink to the outer surface of the printing plate carried on the plate carried on master cylinder 1. One of the inking rollers 4 acquires ink on its outer surface from an ink reservoir 3 and ink is applied to the other rollers 5, 6, 7, 8, 9, 10 and 11 by rotative contact therewith. This smooths the ink and finally when the ink is applied to the printing plate by the ink form rollers 12 and 13 it is applied in a smooth even layer.

The fountain solution is carried in a fountain solution reservoir 15 and is picked up on a dampening roller 16 which is partially submerged therein. The fountain solution is then distributed by rotative contact with rollers 17 and 18 being finally evenly distributed to the dampening form roller 19 which applies the fountain solution to the master cylinder printing plate. It is again noted that the fountain solution is applied to the printing plate prior to ink being applied thereto by the ink form rollers 12 and 13. Thus, the fountain solution is attracted to the printing plate by the hydrophilic areas thereon. Subsequently the ink is attracted to the oleophilic areas of the printing plate by the ink form rollers 12 and 13.

Referring now to FIG. 2, there is shown a schematic end view of rollers of a lithographic printing press according to a preferred embodiment of the present invention. The system utilizes the same master or plate cylinder 1 and blanket cylinder 2 as in the prior art system of FIG. 1. There is also very little difference in the inking system. There is an ink reservoir 30, inking rollers 20, 21, 22, 23, 24, 25, 26, 27, 28 and 29. The rollers 28 and 29 are ink form rollers, similar to ink form rollers 12 and 13 is FIG. 1, which apply ink to the oleophilic areas of the printing plate carried on the master or plate cylinder 1.

The major difference between the system of the present invention and that of the prior art is in the dampening system. The dampening system of the present invention provides a dampening form roller 31 which engages the printing plate carried on the master cylinder 1 after the printing plate has been engaged by the ink form rollers 28 and 29 and prior to engagement of the printing plate with the blanket cylinder 2. Thus, ink is applied to the printing plate first and then fountain solution is applied to the printing plate subsequently thereto.

The dampening system includes a reservoir of fountain solution 40 in which the dampening form roller 31 is partially submerged for rotation therein. A metering roller 32 engages the surface of the dampening roller 34 after it emerges from the reservoir 40 to regulate the amount of fountain solution applied to the printing plate by the dampening form roller 31. The dampening form roller 31 rotates about a shaft 34 on which is mounted a gear (not shown) for engagement with a gear carried by the master cylinder 1 (not shown). The metering roller 32 is mounted on a central shaft 35 the ends of which may be supported by bearings (not shown) which may be moved closer to or further away from the dampening form roller 31 to regulate the flow of fountain solution to the printing plate. A third roller 33 engages the surface of the metering roller 32. The roller 33 may be mounted on a shaft 36 operatively associated with what is sometimes referred to as a “worm and dog” mechanism (not shown) which causes the roller 33 to oscillate on the axis of the shaft 36 to aid in evenly spreading the fountain solution on the metering roller 32 and consequently on the dampening form roller 31. The outer surfaces of the metering roller 32 are harder than the outer surfaces of the form roller 31 and the third roller 33. It will be noted that the dampening form roller 31, the rollers 32 and 33 and the reservoir of fountain solution 40 are all at a lower elevation than the set of inking rollers 20-29.

In summary, the operation of the system of the present invention is as follows. A lithographic printing plate, chemically treated with hydrophilic and oleophilic areas, is attached to the master cylinder 1. As the master cylinder 1 rotates, in a counter clockwise manner, ink is applied to oleophilic areas of the printing plate by form rollers 28 and 29 which are supplied with ink from ink reservoir 30 and ink rollers 20-27.

As the master cylinder 1 continues to rotate, fountain solution is applied to hydrophilic areas of the printing plate carried by the master cylinder 1 by dampening form roller 31. The dampening form roller 31, rotating clockwise, is partially immersed in the fountain solution reservoir 40. The metering roller, which is harder than roller 31, fictionally engages the dampening form roller 31, in effect, squeezing the surface of roller 31 to regulate the amount of fountain solution which is applied to the hydrophilic areas of the printing plate.

The amount of fountain solution can be regulated by moving the shaft 35 of the metering roller closer to (for less solution) or further from (for more solution) the shaft 34 of the form roller 31. As previously mentioned, this can be accomplished by moving the bearings (not shown) in which the ends of shaft 35 are carried closer to or further away from the shaft 34 of dampening form roller 31.

The roller 33 frictionally engages the metering roller 32, rotating therewith but in the opposite direction. At the same time, it also axially oscillates helping to evenly spread fountain solution on metering roller 32 and dampening form roller 31.

As the master cylinder 1 continues to rotate, the printing plate carried thereby, with both ink and fountain solution applied thereto, engages the blanket cylinder 2 leaving an inked print image thereon. Paper (not shown) is fed between the blanket cylinder 2 and an impression cylinder (not shown) adjacent thereto. An impression of wet ink is left on the paper by the blanket cylinder 2. The cycle is then repeated with the printing plate again receiving ink from the ink form rollers 28, 29, fountain solution from dampening form roller 31 and paper receiving wet ink from blanket roller 2.

As stated, the system of the present invention provides greater clarity of print and increases the ability to lay down more ink. It could also allow a reduction in the number of ink and dampening rollers, resulting in a printing press of reduced cost.

A single embodiment of the present invention has been described herein. However, many variations of the invention will be apparent to those skilled in the printing art. Accordingly, it is intended that the scope of the invention be limited only by the claims which follow.

1. Apparatus for an offset lithographic printing press having a master cylinder on which a lithographic printing plate may be mounted for rotating contact with the surface of a blanket cylinder and of the type having a set of dampening rollers for applying a fountain solution to said printing plate and a separate set of ink rollers for applying ink to said printing plate, said set of ink rollers comprising at least one ink form roller for engagement with said printing plate for applying said ink thereto prior to engagement of said printing plate with said blanket cylinder;
said apparatus being further characterized in that said set of dampening rollers comprises a dampening form roller which engages said printing plate after engagement by said ink form roller for applying said fountain solution thereto prior to said engagement of said printing plate with said blanket cylinder.

2. The offset lithographic printing press apparatus of claim 1 comprising a reservoir of fountain solution in which said dampening form roller is partially submerged for rotation therein.

3. The offset lithographic printing press apparatus set forth in claim 2 in which said dampening form roller and said reservoir of fountain solution are disposed at a lower elevation than said ink form roller.

4. The offset lithographic printing press apparatus set forth in claim 2 including a metering roller which engages the surface of said dampening form roller after it emerges from said reservoir of fountain solution to regulate the amount of fountain solution applied to said printing plate by said dampening form roller.

5. The offset lithographic printing press apparatus set forth in claim 4 in which said metering roller is provided with a central shaft the ends of which are supported by bearings which may be moved closer to or further from said dampening form roller to regulate said fountain solution applied to said printing plate.

6. The offset lithographic printing press apparatus set forth in claim 4 in which said set of dampening rollers includes a third roller which engages the surface of said metering roller to aid in evenly spreading said fountain solution on said metering roller.

7. The offset lithographic printing press apparatus of claim 6 in which the outer surfaces of said metering roller are harder than the outer surfaces of said dampening form roller and said third roller.

8. The offset lithographic printing press apparatus set forth in claim 6 in which said third roller is mounted on a shaft which is operatively connected to a mechanism by which said third roller is axially oscillated as it rotates.
